(19) United States
(12) Patent Application Publication
(10) Pub. No.: US 2026/0065589 A1
(43) Pub. Date: Mar. 5, 2026

(54) BOUNDING VOLUME HIERARCHY CACHING BY STORING TOPOLOGY

(71) Applicant: Advanced Micro Devices, Inc., Santa Clara, CA (US)

(72) Inventors: Andreas Leitner, Munich (DE); David Ronald Oldcorn, Milton Keynes (GB)

(73) Assignee: Advanced Micro Devices, Inc., Santa Clara, CA (US)

(21) Appl. No.: 18/816,548

(22) Filed: Aug. 27, 2024

(51) Int. Cl. G06T 17/00; G06T 1/60

(52) U.S. Cl. CPC G06T 17/005; G06T 1/60; G06T 2210/12

(57) ABSTRACT

In order to perform ray tracing operations, a ray tracing pipeline uses one or more bounding volume hierarchies (“BVHs”) that act as an acceleration structure for accessing the geometry of a scene. In applications such as video games, simulations, or other real-time applications, geometry of the scene changes frequently such as at every frame. Thus, to have appropriate information for ray tracing, a BVH is built quite frequently. Such an operation is an expensive one. Thus, efficient techniques for BVH construction are desirable. Thus, techniques are provided herein for BVH caching BVH information. In general, these caching operations store portions of a BVH in a cache when such portions are initially encountered. Later, when that geometry is re-accessed, the caching operations search the cache for the BVH portions in the cache and uses such BVH portions if found. In some examples, the BVH cache persists between application executions.

### BACKGROUND

In image synthesis, ray tracing is utilized to find a nearest intersection of a given ray with a scene where light propagation is simulated. Advances in ray tracing are frequently being made.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail, according to an example;

FIG. 3 illustrates a ray tracing pipeline for rendering graphics using a ray tracing technique, according to an example;

FIG. 4 is an illustration of a bounding volume hierarchy (“BVH”), according to an example;

FIG. 5 illustrates caching operations for a BVH, according to an example;

FIG. 6 illustrates an example two-level BVH including a top-level BVH and bottom-level BVHs;

FIG. 7 illustrates operations for caching BVH topology, according to an example;

FIG. 8 illustrates restoration of the BVH from the cached topology and incoming vertices, according to an example; and

FIG. 9 is a flow diagram of a method for performing BVH operations, according to an example.

### DETAILED DESCRIPTION

Ray tracing is a rendering technique whereby rays are cast into a scene and pixels of a render target are colored based on which objects the rays intersect. To speed such operations up, a ray tracing system typically builds an acceleration structure such as a bounding volume hierarchy (“BVH”). Such a structure has a hierarchy of levels, where each level can include bounding volumes that bound the geometry of lower levels.

Building a BVH involves encoding the application geometry into a format that can be efficiently searched by the ray tracing traversal engine. The resulting tree has within it a topology that defines where the geometry appears on the tree and how the very many individual bounds are efficiently related to each other to allow for efficient searching during traversal. Generating the topology is one of the most expensive parts of the BVH building process.

Applications may later find it useful to update the BVH if, for example, the geometry inside it is animated, and this can be accelerated by refitting the BVH instead of rebuilding it. The process of refitting a BVH avoids having to regenerate the topology of the BVH by using the topology already present in the tree.

The topology does not include all information of the BVH but instead a subset of that information—“BVH topology”—that can be extracted from the BVH tree independently of the geometric data stored within it. Tree topologies generally have the property that they compress well. It is therefore possible to extract the topology from the BVH and store this in a cache, which can be compressed very efficiently. In some examples, this topology includes an indication of which nodes are present in the BVH, as well as the connectivity between nodes, and references to the vertices stored in the leaf nodes. The cache is indexed using a key generated from vertex information from which the BVH topology is generated. Thus on a subsequent access, a key generated by the same vertex information, which would form the same BVH, is used to access the BVH topology. After this, an entity such as the driver rebuilds the BVH using the topology from the cache and vertex information supplied by the application.

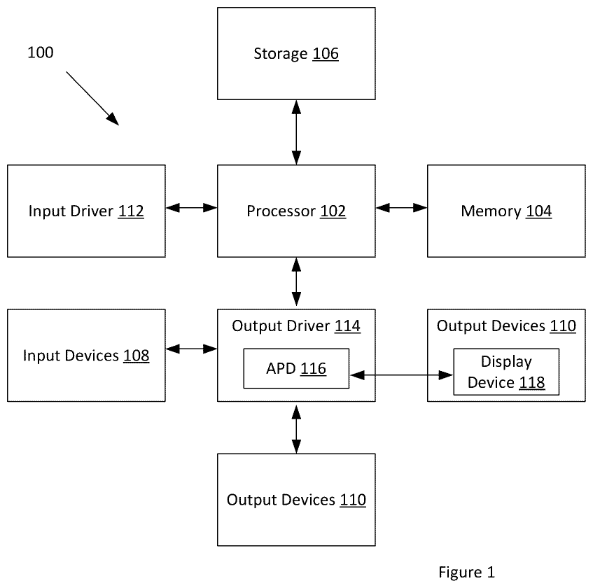

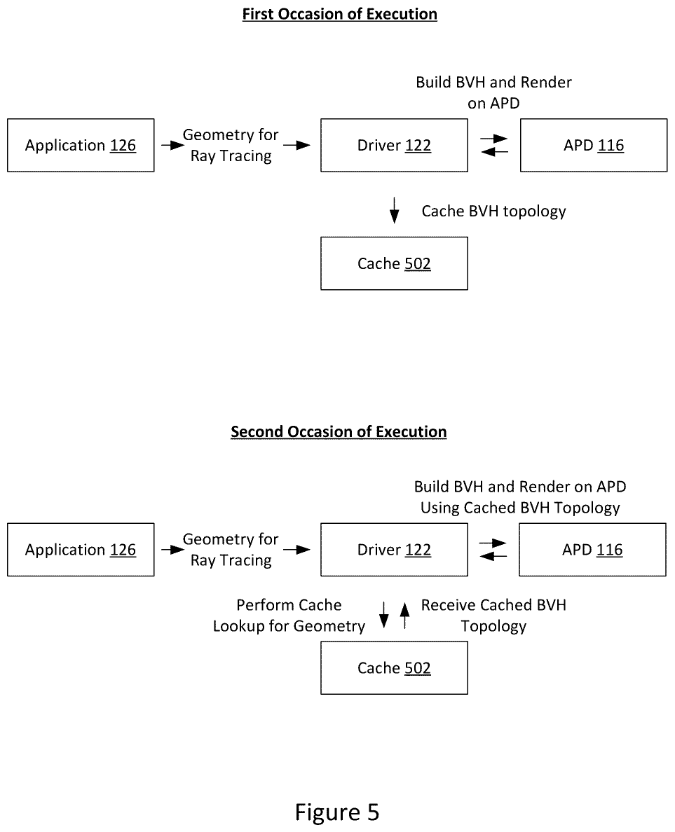

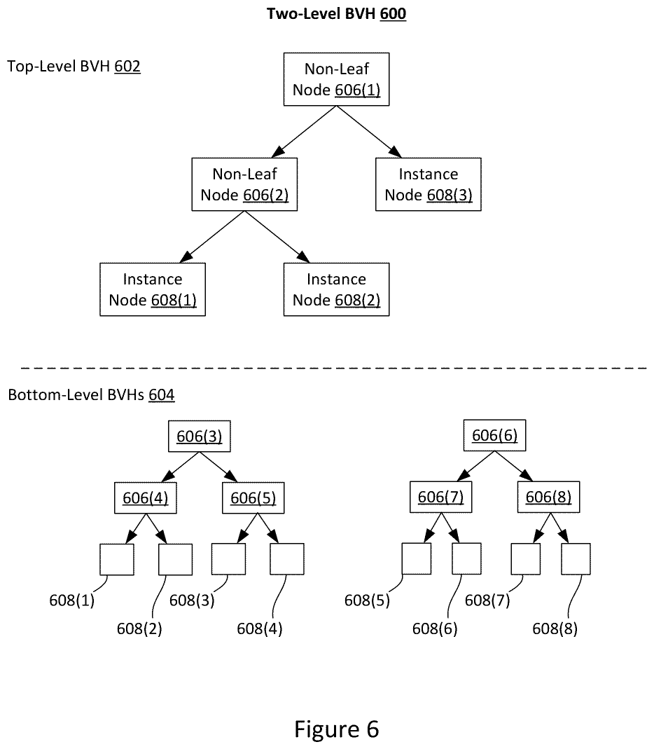

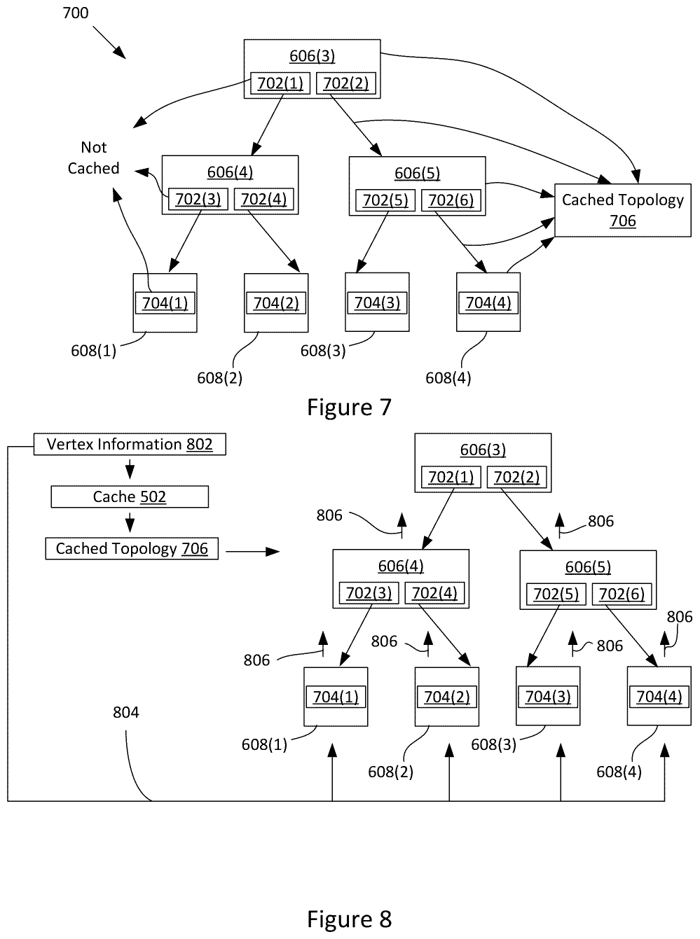

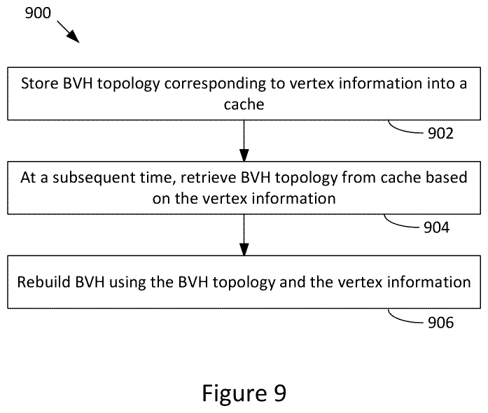

In the present disclosure, FIGS. 1-4 provide background for ray tracing. FIG. 5 illustrates caching operations for a BVH, according to an example. FIG. 6 illustrates a two-level BVH. FIG. 7 illustrates caching BVH topology and FIG. 8 illustrates rebuilding a BVH using the cached topology. FIG. 9 illustrates a method for utilizing cached BVH topology.

FIG. 1 is a block diagram of an example device 100 in which one or more features of the disclosure can be implemented. The device 100 can include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 114 includes an accelerated processing device (“APD”) 116 which is coupled to a display device 118. The APD accepts compute commands and graphics rendering commands from processor 102, processes those compute and graphics rendering commands, and provides pixel output to display device 118 for display. As described in further detail below, the APD 116 includes one or more parallel processing units to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a SIMD paradigm may perform the functionality described herein. Alternatively, it is contemplated that computing systems that do not perform processing tasks in accordance with a SIMD paradigm performs the functionality described herein.

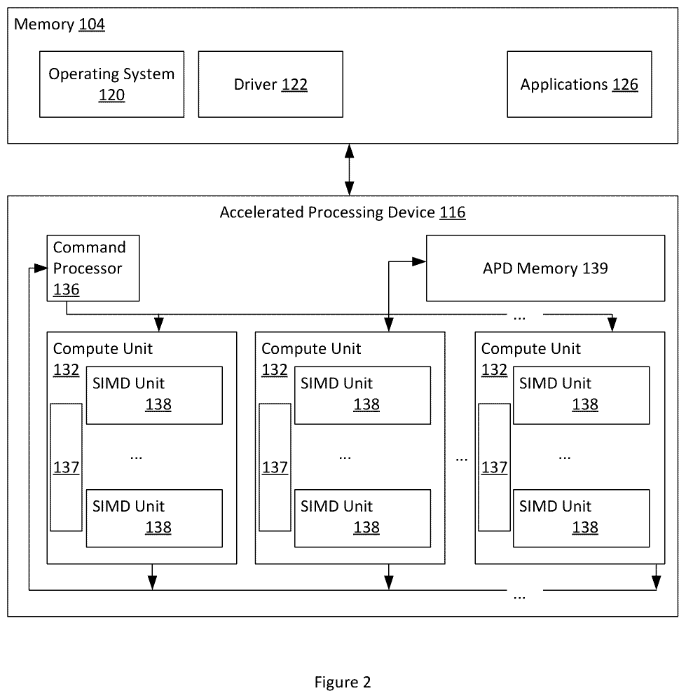

FIG. 2 is a block diagram of the device 100, illustrating additional details related to execution of processing tasks on the APD 116, according to an example. The processor 102 maintains, in system memory 104, one or more control logic modules for execution by the processor 102. The control logic modules include an operating system 120, a driver 122, and applications 126. These control logic modules control various features of the operation of the processor 102 and the APD 116. For example, the operating system 120 directly communicates with hardware and provides an interface to the hardware for other software executing on the processor 102. The driver 122 controls operation of the APD 116 by, for example, providing an application programming interface (“API”) to software (e.g., applications 126) executing on the processor 102 to access various functionality of the APD 116. The driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that perform operations at the request of the processor 102 in a parallel manner according to a SIMD paradigm. Each compute unit 132 includes a local data share (“LDS”) 137 that is accessible to wavefronts executing in the compute unit 132 but not to wavefronts executing in other compute units 132. A global memory 139 stores data that is accessible to wavefronts executing on all compute units 132. In some examples, the local data share 137 has faster access characteristics than the global memory 139 (e.g., lower latency and/or higher bandwidth). Although shown in the APD 116, the global memory 139 can be partially or fully located in other elements, such as in system memory 104 or in another memory not shown or described. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A scheduler 136 performs operations related to scheduling various wavefronts on different compute units 132 and SIMD units 138.

The parallelism afforded by the compute units 132 is suitable for graphics related operations such as pixel value calculations, vertex transformations, and other graphics operations. Thus in some instances, a graphics pipeline, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline (e.g., custom operations performed to supplement processing performed for operation of the graphics pipeline). An application 126 or other software executing on the processor 102 transmits programs that define such computation tasks to the APD 116 for execution.

The APD 116 is configured to implement features of the present disclosure by executing a plurality of functions as described in more detail below. For example, the APD 116 is configured to receive images comprising one or more three dimensional (3D) objects, divide images into a plurality of tiles, execute a visibility pass for primitives of an image, divide the image into tiles, execute coarse level tiling for the tiles of the image, divide the tiles into fine tiles and execute fine level tiling of the image. Optionally, the front end geometry processing of a primitive determined to be in a first one of the tiles can be executed concurrently with the visibility pass.

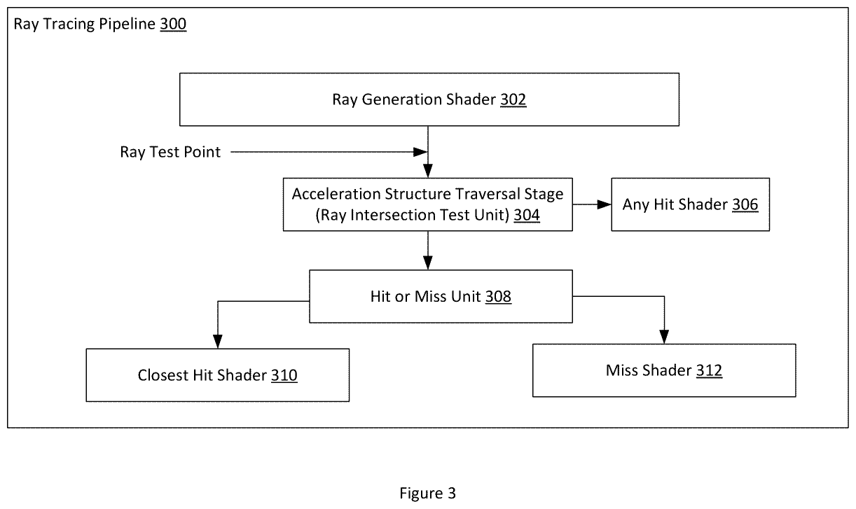

FIG. 3 illustrates a ray tracing pipeline 300 for rendering graphics using a ray tracing technique, according to an example. The ray tracing pipeline 300 provides an overview of operations and entities involved in rendering a scene utilizing ray tracing. A ray generation shader 302, any hit shader 306, closest hit shader 310, and miss shader 312 are shader-implemented stages that represent ray tracing pipeline stages whose functionality is performed by shader programs executing in the SIMD unit 138. Any of the specific shader programs at each particular shader-implemented stage are defined by application-provided code (i.e., by code provided by an application developer that is pre-compiled by an application compiler and/or compiled by the driver 122). The acceleration structure traversal stage 304 performs a ray intersection test to determine whether a ray hits a triangle.

The various programmable shader stages (ray generation shader 302, any hit shader 306, closest hit shader 310, miss shader 312) are implemented as shader programs that execute on the SIMD units 138. The acceleration structure traversal stage 304 is implemented in software (e.g., as a shader program executing on the SIMD units 138), in hardware, or as a combination of hardware and software. The hit or miss unit 308 is implemented in any technically feasible manner, such as as part of any of the other units, implemented as a hardware accelerated structure, or implemented as a shader program executing on the SIMD units 138. The ray tracing pipeline 300 may be orchestrated partially or fully in software or partially or fully in hardware, and may be orchestrated by the processor 102, the scheduler 136, by a combination thereof, or partially or fully by any other hardware and/or software unit. The term “ray tracing pipeline processor” used herein refers to a processor executing software to perform the operations of the ray tracing pipeline 300, hardware circuitry hard-wired to perform the operations of the ray tracing pipeline 300, or a combination of hardware and software that together perform the operations of the ray tracing pipeline 300.

The ray tracing pipeline 300 operates in the following manner. A ray generation shader 302 is executed. The ray generation shader 302 sets up data for a ray to test against a triangle and requests the acceleration structure traversal stage 304 test the ray for intersection with triangles.

The acceleration structure traversal stage 304 traverses an acceleration structure, which is a data structure that describes a scene volume and objects (such as triangles) within the scene, and tests the ray against triangles in the scene. In various examples, the acceleration structure is a bounding volume hierarchy. The hit or miss unit 308, which, in some implementations, is part of the acceleration structure traversal stage 304, determines whether the results of the acceleration structure traversal stage 304 (which may include raw data such as barycentric coordinates and a potential time to hit) actually indicates a hit. For triangles that are hit, the ray tracing pipeline 300 triggers execution of an any hit shader 306. Note that multiple triangles can be hit by a single ray. It is not guaranteed that the acceleration structure traversal stage will traverse the acceleration structure in the order from closest-to-ray-origin to farthest-from-ray-origin. The hit or miss unit 308 triggers execution of a closest hit shader 310 for the triangle closest to the origin of the ray that the ray hits, or, if no triangles were hit, triggers a miss shader.

Note, it is possible for the any hit shader 306 to “reject” a hit from the ray intersection test unit 304, and thus the hit or miss unit 308 triggers execution of the miss shader 312 if no hits are found or accepted by the ray intersection test unit 304. An example circumstance in which an any hit shader 306 may “reject” a hit is when at least a portion of a triangle that the ray intersection test unit 304 reports as being hit is fully transparent. Because the ray intersection test unit 304 only tests geometry, and not transparency, the any hit shader 306 that is invoked due to a hit on a triangle having at least some transparency may determine that the reported hit is actually not a hit due to “hitting” on a transparent portion of the triangle. A typical use for the closest hit shader 310 is to color a material based on a texture for the material. A typical use for the miss shader 312 is to color a pixel with a color set by a skybox. It should be understood that the shader programs defined for the closest hit shader 310 and miss shader 312 may implement a wide variety of techniques for coloring pixels and/or performing other operations.

A typical way in which ray generation shaders 302 generate rays is with a technique referred to as backwards ray tracing. In backwards ray tracing, the ray generation shader 302 generates a ray having an origin at the point of the camera. The point at which the ray intersects a plane defined to correspond to the screen defines the pixel on the screen whose color the ray is being used to determine. If the ray hits an object, that pixel is colored based on the closest hit shader 310. If the ray does not hit an object, the pixel is colored based on the miss shader 312. Multiple rays may be cast per pixel, with the final color of the pixel being determined by some combination of the colors determined for each of the rays of the pixel. As described elsewhere herein, it is possible for individual rays to generate multiple samples, which each sample indicating whether the ray hits a triangle or does not hit a triangle. In an example, a ray is cast with four samples. Two such samples hit a triangle and two do not. The triangle color thus contributes only partially (for example, 50%) to the final color of the pixel, with the other portion of the color being determined based on the triangles hit by the other samples, or, if no triangles are hit, then by a miss shader.

It is possible for any of the any hit shader 306, closest hit shader 310, and miss shader 312, to spawn their own rays, which enter the ray tracing pipeline 300 at the ray test point. These rays can be used for any purpose. One common use is to implement environmental lighting or reflections. In an example, when a closest hit shader 310 is invoked, the closest hit shader 310 spawns rays in various directions. For each object, or a light, hit by the spawned rays, the closest hit shader 310 adds the lighting intensity and color to the pixel corresponding to the closest hit shader 310. It should be understood that although some examples of ways in which the various components of the ray tracing pipeline 300 can be used to render a scene have been described, any of a wide variety of techniques may alternatively be used.

As described above, the determination of whether a ray hits an object is referred to herein as a “ray intersection test.” The ray intersection test involves shooting a ray from an origin and determining whether the ray hits a triangle and, if so, what distance from the origin the triangle hit is at. For efficiency, the ray tracing test uses a representation of space referred to as a bounding volume hierarchy. This bounding volume hierarchy is the “acceleration structure” described above. In a bounding volume hierarchy, each non-leaf node represents an axis aligned bounding box that bounds the geometry of all children of that node. In an example, the base node represents the maximal extents of an entire region for which the ray intersection test is being performed. In this example, the base node has two children that each represent mutually exclusive axis aligned bounding boxes that subdivide the entire region. Each of those two children has two child nodes that represent axis aligned bounding boxes that subdivide the space of their parents, and so on. Leaf nodes represent a triangle against which a ray test can be performed. It should be understood that where a first node points to a second node, the first node is considered to be the parent of the second node.

The bounding volume hierarchy data structure allows the number of ray-triangle intersections (which are complex and thus expensive in terms of processing resources) to be reduced as compared with a scenario in which no such data structure were used and therefore all triangles in a scene would have to be tested against the ray. Specifically, if a ray does not intersect a particular bounding box, and that bounding box bounds a large number of triangles, then all triangles in that box can be eliminated from the test. Thus, a ray intersection test is performed as a sequence of tests of the ray against axis-aligned bounding boxes, followed by tests against triangles.

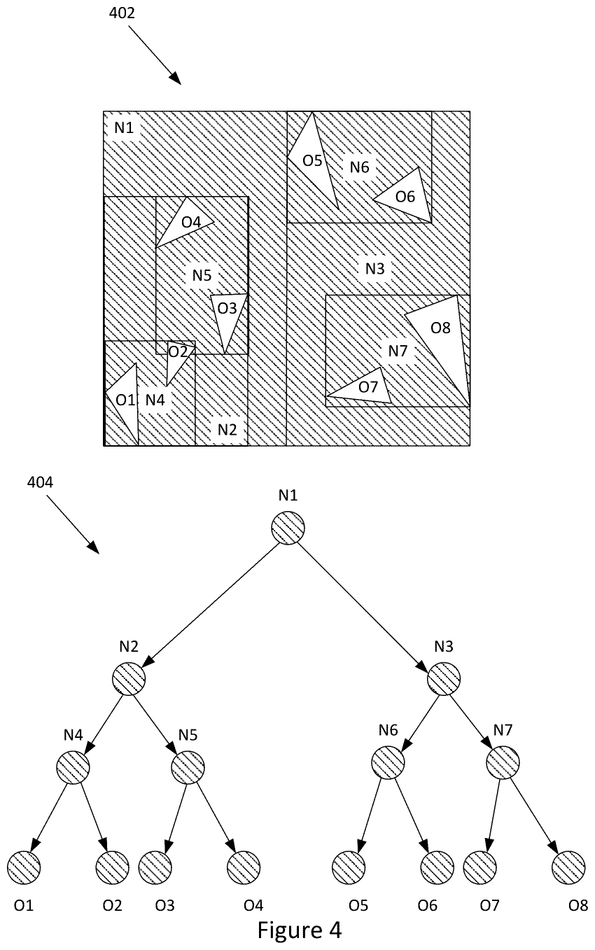

FIG. 4 is an illustration of a bounding volume hierarchy, according to an example. For simplicity, the hierarchy is shown in 2D. However, extension to 3D is simple, and it should be understood that the tests described herein would generally be performed in three dimensions.

The spatial representation 402 of the bounding volume hierarchy is illustrated in the left side of FIG. 4 and the tree representation 404 of the bounding volume hierarchy is illustrated in the right side of FIG. 4. The non-leaf nodes are represented with the letter “N” and the leaf nodes are represented with the letter “0” in both the spatial representation 402 and the tree representation 404. A ray intersection test would be performed by traversing through the tree 404, and, for each non-leaf node tested, eliminating branches below that node if the box test for that non-leaf node fails. For leaf nodes that are not eliminated, a ray-triangle intersection test is performed to determine whether the ray intersects the triangle at that leaf node.

In an example, the ray intersects O₅ but no other triangle. The test would test against N₁, determining that that test succeeds. The test would test against N₂, determining that the test fails (since O₅ is not within N₁). The test would eliminate all sub-nodes of N₂ and would test against N₃, noting that that test succeeds. The test would test N₆ and N₇, noting that N₆ succeeds but N₇ fails. The test would test O₅ and O₆, noting that O₅ succeeds but 06 fails. Instead of testing 8 triangle tests, two triangle tests (O₅ and O₆) and five box tests (N₁, N₂, Ns, N₆, and N₇) are performed.

As just stated, in order to perform ray tracing operations, the ray tracing pipeline 300 uses one or more bounding volume hierarchies (“BVHs”) that act as an acceleration structure for accessing the geometry of a scene. In general, applications update BVH information to update the scene that is being rendered. For a two-level BVH (discussed in greater detail below with respect to FIG. 6) such update generally includes rebuilding the top-level BVH every frame. In addition to this, however, some bottom-level BVHs do need to be updated every frame, but a rebuild is not necessarily required—a refit operation can be used to update such bottom-level BVHs. A refit operation maintains the topology of the BVH while updating non-topology data. Specifically, a refit operation updates elements such as the bounding volumes of nodes of the BVH, but generally does not modify the topology of the BVH.

Techniques are provided herein for BVH caching, which allows for certain optimizations that alleviate the performance issues related to building the BVH. In general, these caching operations store portions of a BVH in a cache when such portions are initially encountered. Later, that geometry is re-accessed and the caching operations search the cache for the BVH portions and use such BVH portions if found. In some examples, the BVH cache persists between application executions so that a subsequent application execution can make use of previously cached BVH information. In an example, for the first execution of an application such as a game, that application builds at least a portion of a BVH which is then cached. Then, after the application is exited and relaunched at a later time or date, the application searches the cache for the BVH information and uses that information if found. Such information can even persist between device shutdown by storing the cached BVH in persistent storage such as a hard drive or solid state drive.

FIG. 5 illustrates caching operations for a BVH, according to an example. The example operations of FIG. 5 illustrate a first occasion of execution in which BVH information is cached and a second occasion of execution in which the cache BVH information is retrieved and utilized to perform ray tracing operations. It should be understood that although a first occasion of execution and second occasion of execution are shown, these should be understood as being examples and that the caching operation and subsequent retrieval of cached information can occur at any technically feasible time and in any technically feasible order. In some examples, the creation and caching of the BVH topology occurs once over a plurality of application executions and that cached topology is used multiple times.

In the first occasion of execution, an application 126 is executing and performing operations related to ray tracing. Specifically, the application 126 requests, via the driver 122, for the APD 116 to perform ray tracing operations. Part of this request includes the application 126 providing geometry for ray tracing to the driver 122. The geometry specifies, among other things, vertex information for geometry to be rendered, where the vertex information includes positional coordinates (e.g., in a three-dimensional space). In some examples, the geometry also specifies other information such as triangle information (e.g., how the vertices connect to make triangles), mesh information (e.g., how the triangles and/or vertices connect to make larger mesh geometries), material information (e.g., the appearance of the mesh/geometry), and a wide variety of other information types. In some examples, the application 126 indicates that ray tracing should be used to perform this rendering.

In order to render the geometry, the driver 122 obtains BVH information. In the first occasion of execution, no BVH information is cached in the cache 502 so the driver 122 requests the APD 116 to build the BVH. The APD 116 builds the BVH and provides that BVH to the driver 122. The driver 122 stores at least a portion of the BVH into the cache 502 along with a cache key that refers to that portion. In some examples, the portion includes topology information for the BVH. In some examples, this topology information is for a bottom-level acceleration structure of a two-level acceleration structure (described in further detail elsewhere herein). In some examples, the topology information includes the structure of the BVH, including which non-leaf nodes are present, which leaf nodes are present, and what vertices are included in each leaf node, but does not include the vertex information such as vertex coordinates. In some examples, the indication of what vertices are included in each leaf node includes vertex indices but, again, not the coordinates themselves. The indices refer to unique vertices with an identifier (such as a unique number), where such unique vertices are further defined by vertex coordinates not included in the indices. Thus as can be seen, the driver 122 stores BVH topology into the cache 502, where the topology includes the information about the nodes of a BVH as well as which indices are included in which leaf nodes of that BVH, but does not include vertex information.

In some examples, the cached BVH topology information includes a bottom-level acceleration structure (“BLAS”) identifier that explicitly identifies the BLAS that the BVH topology is for. A BLAS is a part of a two-level BVH that includes a top-level BVH that includes instance nodes that point to BLASs, and BLASs that define more detailed geometry. An instance node references an instance, which is the combination of an identifier for a bottom level acceleration structure, an instance transform, and potentially other data. An instance transform describes a transform to be applied to the geometry of a bottom level acceleration structure. In various examples, such a transform applies translation (e.g., movement), rotation, and scaling. An instance is a “copy” of the geometry represented in a bottom level acceleration structure, with a transform applied. This type of copying-with-transformation allows for conservation of data in a two-level BVH through reuse with modifications represented by the instance transform. In summary, in some examples, the cached BVH topology information includes a BLAS identifier (or includes some other information for linking the information in that cached topology with the BLAS of a BVH) as well as topology for the cached BVH, but does not include vertex information.

A refit operation is in contrast to a full BVH build operation. Specifically, a full BVH build operation starts with only the geometry and needs to build the entire topology of the BVH tree based on that geometry. Thus, the BVH build operation determines the tree structure of the BVH, including which nodes exist, which nodes point to which other nodes, and which nodes include which vertices and/or triangles. By contrast, a refit operation begins with topology and vertex information, including an indication of which vertices belong in which leaf nodes, and generates the bounding volumes for the leaf nodes and non-leaf nodes based on this information. In an example, the refit operation begins with an already-built BVH tree, in which is encoded BVH topology information, which includes the tree structure of the BVH and specifies which vertices are in which leaf nodes. This specifying is done via vertex indices. The refit operation then generates bounding volumes for each non-leaf node and leaf node in a bottom-up manner. For each leaf nodes, the refit operation fetches the vertex information for that leaf node and generates a bounding volume for that leaf node, where the bounding volume tightly fits the geometry defined by the vertex information (e.g., tightly fits the vertices). For non-leaf nodes, the refit operation generates the bounding volume for that non-leaf node, where the bounding volume bounds all bounding volumes that are children of that non-leaf node (e.g. tightly fits those bounding volumes). It is possible for one or more such nodes to be oriented, that is, not aligned with the coordinate axes but instead oriented with respect to one or more such coordinate axes. In some examples, the cached topology stores such orientation information. In summary, a refit operation generates bounding volume information for the BVH based on the vertex information, as this bounding volume information is not stored in the cached topology, which stores the parent-child relationships of a set of nodes as well as an indication, for each leaf node, of which vertices is included in that leaf node, where the indication is made via indices.

The second occasion of execution includes the following operations. The application 126 provides geometry for ray tracing to the driver 122 and requests the driver 122 to perform ray tracing using that geometry. The driver 122 performs a lookup on the cache 502 using the geometry and discovers the information stored in the cache in the first occasion of execution. The cache 502 returns this information to the driver 122. The driver does not perform a full BVH build with this information, but instead performs a refit operation to produce a BVH. The driver 122 requests the APD 116 perform ray tracing operations with the BVH generated using the refit operation.

In some examples, the overall BVH used by the APD 116 to perform ray tracing is a two-level BVH. For example, as stated above, the cached BVH topology includes BVH information for a bottom-level acceleration structure. FIG. 6 illustrates an example two-level BVH 600 including a top-level BVH 602 and bottom-level BVHs 604.

The top-level BVH 602 includes a plurality of non-leaf nodes 606 and a plurality of instance nodes 608. Each non-leaf node 606 includes one or more pointers to one or more other nodes. Each pointer is associated with a bounding volume that tightly bounds the geometry of the node pointed to. Each instance node 608 includes a pointer to a bottom-level BVH 604 as well as an instance transform. The bottom-level BVH 604 defines geometry. The instance transform defines a transform (e.g., an affine transformation, including one or more of translation, rotation, scaling, and shear) that can be applied to the geometry of the bottom-level BVH 604. Bottom-level BVHs 604 allow for copies of geometry, with modifications, to be used in a scene while eliminating some duplication.

In some examples, it is the topology of the bottom-level BVHs 604 that are cached, and not that of the top-level BVHs 602. More specifically, typically, between frames, bottom-level BVHs 604 generally do not change a great deal, or at least not as much as the top-level BVHs 602. More specifically, the bottom-level BVHs 604 are generally associated with scene objects or meshes. While these objects can move within the scene and can be changed to a certain degree, these objects stay relatively constant in terms of their geometric make-up. By contrast, the top-level BVH 602 generally represents the geometry of an entire scene or some large collection of geometry. Such top-level BVHs 602 can vary greatly and depend on highly variable changes in the components of the scenes. For example, objects can move in relatively arbitrary manners. Because the top-level BVH 602 depends in part on the relative positions of these objects, such BVH can vary greatly. Thus there may not be a high benefit associated with caching the topology of the top-level BVHs 602.

FIG. 7 illustrates operations for caching BVH topology, according to an example. The BVH 700 of FIG. 7 includes non-leaf nodes 606 and leaf nodes 608. The non-leaf nodes 606 include references 702 and the leaf nodes 608 include vertex data 704. The references 702 include a bounding volume that tightly bounds the geometry of the children of a referenced node as well as the pointer to the referenced node (arrows). The vertex data 704 includes data that indicates the positions of the vertices that correspond to a particular leaf node 608.

The topology data includes the “structure” of the BVH but not the geometry information. More specifically, the topology indicates which nodes—non-leaf nodes 606 and leaf nodes 608 exist—as well as the connectivity between nodes—that is, the pointer of the reference 702, but not the bounding volume of the reference 702. In some examples, the topology data includes an indication for each node of whether that node is a non-leaf node 606 or a leaf node 608. The topology data for leaf nodes 608 includes indices for the vertices included in each leaf node, but does not include the actual vertex coordinates. In summary, the cached topology 706 includes an indication of the structure of the BVH, including what nodes exist, the pointers from nodes to others or other non-pointer information about potential connectivity (e.g., information other than pointers that specifies the connectivity of the BVH), and what the types of the nodes are. The leaf nodes also include indices for each vertex in that leaf node. The non-leaf nodes do not store bounding volume information and the leaf nodes do not store vertex data.

FIG. 8 illustrates restoration of the BVH from the cached topology and incoming vertices, according to an example. In this example, a driver 122 receives vertex information 802 from an application 126 (or other entity) for rendering via ray tracing. The driver 122 applies the vertex information 802 to the cache 502 and retrieves the cached topology 706.

In some examples, the application 126 provides the vertex information 802 to the driver 122 for rendering. The vertex information specifies at least the coordinates of vertices of geometry (e.g., triangles arranged in a mesh) to be rendered. The driver 122 performs a lookup for this vertex information 802 in the cache 502 and restores the BVH for that vertex information 802 in the event that such information is already in the cache. In some examples, the driver 122 performs a hash on the vertex information 802 to use as a key into the cache 502. The driver 122 determines that BVH topology for vertex information exists in the cache 502 in the event that the key generated for the vertex information exists in the cache 502. In some examples, the key to the cache is based on one or more of a mesh ID or one or more vertex ID. In some examples, the vertex information 802 includes a set or range of vertex indices, and a hash is generated from this information.

In FIG. 8, the cache 502 does include topology for the vertex information 802 and so the driver 122 rebuilds the BVH based on this topology. Such rebuild includes reconstructing the structure of the BVH, including the nodes and pointers between nodes. Such rebuild also includes placing the vertex information 802 into the leaf nodes 608 (arrow 804). It should be understood that the application 126 provides this vertex information, but this vertex information is not stored in the cached topology 706. The rebuild also includes a refit operation. A refit operation includes building the bounding volumes for each of the references 702. Such refit includes generating the bounding volumes for the references 702, as such information is not included in the cached topology 706.

In some examples, the driver 122 performs a refit in the following manner. The driver calculates the bounding volumes for the leaf nodes 608. The bounding volumes are tightly fitting bounding boxes that tightly bound all of the geometry of the leaf node 608. The driver 122 propagates this information up the BVH (arrows 806). For each non-leaf node 606 that has all leaf nodes 608 as children, the driver 122 sets the bounding volume for that non-leaf node 606 to a volume that bounds all children of that non-leaf node 606. The driver 122 continues generating these bounding volumes, traversing up the tree until all non-leaf nodes and leaf nodes have a bounding volume. At this point, the driver 122 has generated a BVH corresponding to the vertex information 802 and can use this information to perform ray tracing (e.g., by performing intersection tests using the BVH and by performing shading based on such intersection tests).

Herein, where it is stated that the driver 122 performs an operation, this should be interpreted as meaning that the driver 122 performs that operation directly, the driver directs one or more other entities, such as the APD 116 to perform that operation (e.g., via a shader program), or the driver 122 performs a portion of the operation directly and causes another entity to perform another portion of the operation.

In some examples, the driver 122 provides an application programming interface (“API”) that the application 126 uses to perform at least some of the operations described herein. In one example, the application 126, rather than the driver 122, manages the cache 502. In such an example, the application 126 provides vertex information 802 to the driver 122 and requests the driver 122 to generate cacheable topology information (e.g., the cached topology 706 of FIG. 8). The driver 122 returns information identifying the cached topology 706 (such as a handle or pointer to the cached topology in memory) and the application 126 performs subsequent actions such as storing the cached topology 706 in a location such as on a disk drive. To perform rendering, the application 126 provides identifying information for the cached topology 706 to the driver, along with the vertex information 802, and the driver 122 rebuilds the corresponding BVH (as shown, for example, in FIG. 8), and then performs the rendering with that rebuilt BVH. The application 126 handles the caching operations, including performing storage and lookups with the vertex information 802 into the cache 502. In other examples, the caching operations are transparent to the application 126. In other words, in such examples, the application 126 provides vertex information 802 to the driver 122 and the driver 122 performs caching and lookups as described elsewhere herein.

FIG. 9 is a flow diagram of a method 900 for performing BVH operations, according to an example. Although described with respect to the system of FIGS. 1-8, those of skill in the art will understand that any system configured to perform the steps of the method 900 in any technically feasible order falls within the scope of the present disclosure.

At step 902, a processor (e.g., the processor 102) stores a BVH topology 706 corresponding to vertex information 802 into a cache. As described elsewhere herein, in some examples, an application 126 manages the cache for the BVH topology 706. Thus the application 126 instructs the driver 122 to generate cached topology 706 in the event that the application 126 does not have such cached topology in its cache. The driver 122 generates that cached topology and provides that cached topology to the application 126, which stores the BVH topology into its cache. As described elsewhere herein, in some examples, the application 126 utilizes a hash based on the vertex information 802 as a key into the cache. The application 126 performs a lookup into the cache using this key. If such key does not exist in the cache, then the application 126 requests access to a cacheable topology and upon receipt, stores the cached topology into the cache. In other examples, the driver 122 manages the cache. In such example, the application provides the geometry to the driver 122 and the driver checks the cache for cached topology corresponding to the geometry. In the instance that the driver 122 does not find the key for the geometry, the driver 122 generates the cached topology and stores that cached topology into the cache. In some examples, generating the cached topology is performed as described with respect to FIG. 7. Briefly, the driver 122 builds a BVH for the vertex information and then stores the topology, which does not include the bounding volumes or vertex positions, as the cached topology.

At step 904, at a subsequent time (such as for a subsequent frame), the processor 102 (e.g., application 126 or driver 122) retrieves the cached BVH topology based on the vertex information. More specifically, the application 126 provides the vertex information to the driver 122 for rendering. The driver 122 examines the cache using a key that is based on the vertex information. Since the BVH topology for that vertex information is already stored in the cache, the driver 122 obtains that BVH topology.

At step 906, the driver 122 rebuilds the BVH using the BVH topology and the vertex information used as a key into the cache. In some examples, this rebuild is performed as described with respect to FIG. 8. More specifically, the BVH topology includes a BVH structure, which includes an indication of which nodes (leaf nodes and non-leaf nodes) exist in the BVH, and includes pointers from nodes to other nodes (where the pointers are part of the references 702). The leaf nodes of the BVH topology also includes vertex indices, though not vertex coordinates which consume more data. To rebuild the BVH, the driver 122 places the vertex information used as the key into the cache into the corresponding leaf nodes of the BVH topology. Then, the driver 122 generates bounding volumes in a bottom-up manner. To do this, the driver 122 generates bounding volumes for the leaf nodes as volumes that tightly bound the geometry (e.g., triangles) of the leaf nodes. Then, the driver 122 generates bounding volumes for the next higher up non-leaf nodes as the volumes that tightly bound the bounding volumes of the leaf nodes. The driver 122 continues up in this manner, traversing from child to parent while generating the bounding volumes, until a BVH is generated.

In some examples, the driver 122 generates cached topology and then compresses that cached topology before storing that information into the cache. Any form of compression may be used. In one example, the cached topology stores the following information: the leaf node stores, for each primitive, the primitive identifier and the geometry identifier. For each leaf node, the cached topology stores the number of primitives in the leaf node and the pointer from the parent node to the leaf node. For each non-leaf node, the cached topology stores the parent node pointer. In some examples, for each node, the cached topology stores oriented bounding box information such as whether the bounding volume is oriented and a specifier of the orientation (e.g., an index into a set of pre-computed or pre-determined orientations). In some examples, the parent node pointers are not stored for each node but instead, for each node, a pointer (or other connectivity information) of the first child and the child count are stored. This is possible in the event that the nodes have known sizes and a known order.

It should be understood that many variations are possible based on the disclosure herein. Although features and elements are described above in particular combinations, each feature or element can be used alone without the other features and elements or in various combinations with or without other features and elements. In particular, although it is described that a BVH is used, it is possible for other acceleration structures that have a tree-like structure or other type of topology to be used. In such examples, the topology of such acceleration structure is stored as the cached topology and the term “acceleration structure” refers generally to any such structure including a BVH or other acceleration structure.

The various functional units illustrated in the figures and/or described herein (including, but not limited to, the processor 102, the input driver 112, the input devices 108, the output driver 114, the output devices 110, the accelerated processing device 116, the scheduler 136, the compute units 132, the SIMD units 138, the ray tracing pipeline 300, including the ray generation shader 302, acceleration structure traversal stage 304, any hit shader 306, hit or miss unit 308, closest hit shader 310 or miss shader 312 may be implemented as a general purpose computer, a processor, a processor core, or in digital circuitry or analog circuitry, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method comprising:
storing acceleration structure topology corresponding to vertex information into a cache;
retrieving the acceleration structure topology from the cache based on the vertex information; and
rebuilding an acceleration structure based on the acceleration structure topology and the vertex information.

2. The method of claim 1, further comprising requesting a driver to generate the acceleration structure topology based on the vertex information.

3. The method of claim 2, wherein the requesting and the storing are performed by an application via an application programming interface.

4. The method of claim 1, wherein the retrieving is performed in a subsequent frame as the storing.

5. The method of claim 1, wherein the retrieving is performed using a key generated from the vertex information.

6. The method of claim 1, wherein the rebuilding comprises inserting the vertex information into the vertex information.

7. The method of claim 6, wherein the rebuilding also comprises performing a refit information.

8. The method of claim 1, wherein the acceleration structure topology stores oriented bounding box information.

9. The method of claim 1, wherein the storing is performed in response to the acceleration structure topology not being stored in the cache.

10. A system comprising:
a memory; and
a processor configured to perform operations comprising:
storing acceleration structure topology corresponding to vertex information into a cache of the memory;
retrieving the acceleration structure topology from the cache based on the vertex information; and
rebuilding a acceleration structure based on the acceleration structure topology and the vertex information.

11. The system of claim 10, wherein the operations further comprise requesting a driver to generate the acceleration structure topology based on the vertex information.

12. The system of claim 11, wherein the requesting and the storing are performed by an application via an application programming interface.

13. The system of claim 10, wherein the retrieving is performed in a subsequent frame as the storing.

14. The system of claim 10, wherein the retrieving is performed using a key generated from the vertex information.

15. The system of claim 10, wherein the rebuilding comprises inserting the vertex information into the vertex information.

16. The system of claim 15, wherein the rebuilding also comprises performing a refit information.

17. The system of claim 10, wherein the acceleration structure topology stores oriented bounding box information.

18. The system of claim 10, wherein the storing is performed in response to the acceleration structure topology not being stored in the cache.

19. A non-transitory computer-readable medium storing instructions that, when executed by a processor, cause the processor to perform operations comprising:
storing acceleration structure topology corresponding to vertex information into a cache;
retrieving the acceleration structure topology from the cache based on the vertex information; and
rebuilding an acceleration structure based on the acceleration structure topology and the vertex information.

20. The non-transitory computer-readable medium of claim 19, wherein the operations further comprise requesting a driver to generate the acceleration structure topology based on the vertex information.
